(19) United States
(12) Patent Application Publication
(10) Pub. No.: US 2006/0225320 A1
(43) Pub. Date: Oct. 12, 2006

(54) Closure element utilizing uniaxial oriented film

(76) Inventors: Michael E. Dregalla, Kenosha, WI (US); Wayne O'Hara, Parker, CO (US)

Correspondence Address: COCHRAN FREUND & YOUNG LLC, 2026 CARIBOU DR, SUITE 200, FORT COLLINS, CO, 80525, US

(21) Appl. No.: 11/371,976

(22) Filed: Mar. 8, 2006

Related U.S. Application Data
(63) Continuation-in-part of application No. 10/841,714, filed on May 6, 2004.
(60) Provisional application No. 60/468,435, filed on May 6, 2003.

(51) Int. Cl. G09F 3/00

(52) U.S. Cl. 40/311

(57) ABSTRACT

An improved neck band is provided for a container having a neck and removable closure at the end. The neck band is prepared from a straight-tear film, preferably a polypropylene film that has been oriented in a single direction. The neck band is provided with a tab and is attached to the neck and removable closure so that when the tab is pulled, the polymer material separates along a line around the circumference of the neck adjacent the skirt of the removable closure.

### CROSS REFERENCE TO RELATED APPLICATIONS

This application is a continuation-in-part of U.S. patent application Ser. No. 10/841,714 entitled “NECK BAND USING STRAIGHT-TEAR FILM” by Wayne John O'Hara, filed May 6, 2004, which claims the benefit of and priority to U.S. Provisional Patent Application Ser. No. 60/468,435, entitled “IMPROVED NECK BAND USING STRAIGHT-TEAR FILM” by Wayne John O'Hara, filed May 6, 2003. The entire contents of the above listed applications are hereby specifically incorporated herein by reference for all they disclose and teach.

### BACKGROUND OF THE INVENTION

a. Field of the Invention

The present invention relates generally to a neck band or label for a container that comprises a reservoir, a neck, and a removable cap at the end of the neck, and more specifically to a closure band that substantially encircles at least a portion of the cap and the neck of the container.

b. Description of the Background

Neck bands are frequently used on glass or plastic containers having an elongated “neck” with a closure at the end, such as, a screw cap for marketing, product identification and other graphic purposes. Neck bands are also intended help to prevent contaminants from entering the container and provide evidence if tampering prior to consumer. These bands should be easy for consumers to use easy and cost efficient for manufacturers produce.

### SUMMARY OF THE INVENTION

The disclosed embodiments overcome the disadvantages and limitations of the prior art by providing a neck band that is prepared utilizing single or multilayered uniaxially or directionally oriented film (straight-tear film) as a closure element that can be manually separated along a line around a separation point of a container. Preferably, the straight-tear film is a polypropylene-based polymer film and applied to i.e., the neck and cap of a container so that the lines of weakness are parallel to the circumference of the neck. In one embodiment, a tab may be placed on the neck band adjacent the skirt of the cap, so that when the tab is pulled, the polymer material creates a discontinuity around the circumference of the neck by removing a portion of neck band material around the circumference of the container. In another embodiment, an initiation feature incorporated within the polymer material serves to initiate a discontinuity around the circumference of the neck without removing the neck band material.

An embodiment of the present invention may therefore comprise a closure for a container comprising: a directionally oriented polymeric film that can be manually torn in a substantially straight line that corresponds to a predominant direction of orientation of said directionally oriented polymeric film; a base substrate secured to said directionally oriented polymeric film to form a directionally oriented laminate; a first discontinuity in the thickness of said base substrate substantially parallel to, and aligned with, an intended separation line of said laminate that allows said laminate to tear as a single element; a second discontinuity on a perpendicular edge to said intended separation line that concentrates force on at least one tear initiation point; and, an adhesive that adheres at least a portion of said base substrate to said container.

An embodiment of the present invention may therefore comprise a method of providing a closure for a container comprising: providing a directionally oriented polymeric film that can be manually torn in a substantially straight line that corresponds to a predominant direction of orientation of said directionally oriented polymeric film; securing a base substrate to said directionally oriented polymeric film to create a directionally oriented laminate; creating and positioning a first discontinuity in the thickness of said base substrate substantially parallel to, and aligned with, an intended separation line of said laminate that allows said laminate to tear as a single element; creating a second discontinuity on a perpendicular edge to said intended separation line on said laminate that creates at least one tear initiation point; and, adhering at least a portion of said base substrate to said container.

### BRIEF DESCRIPTION OF THE DRAWINGS

In the drawings,

FIG. 1 is a front view of an embodiment of a uniaxially oriented film neck band.

FIG. 2 is a perspective view of a container employing the band of FIG. 1.

FIGS. 3A through 3C depict a side view of the container of FIG. 1 as it is opened, first by manually removing a piece of the neck band by pulling the tab as shown in FIGS. 3A and 3B and then by twisting and removing the cap as shown in FIG. 3C.

FIG. 4 is a schematic illustrating one typical manufacturing technique employed in preparing a directionally oriented material.

FIG. 5 is a schematic diagram illustrating a process for manufacturing neck bands from directionally oriented film.

FIG. 6 is a schematic illustrating the equipment and process employed in applying neck bands of the disclosed embodiments to bottles.

FIG. 7 illustrates an alternative design for directionally oriented neck bands.

FIG. 8 illustrates an additional alternative design for directionally oriented neck bands.

FIG. 9 illustrates yet another alternative design for directionally oriented neck bands.

FIG. 10 FIG. 10 is an edge-on view of an embodiment of a closure element with a directionally oriented polymeric film laminated to a base substrate.

FIG. 11 is an edge-on view of another embodiment of a closure element with a directionally oriented polymeric film laminated to a base substrate.

FIG. 12 is a side view of a process for creating a closure element with a directionally oriented polymeric film laminated to a base substrate.

FIG. 13 is an edge-on view of another embodiment of a closure element with a directionally oriented polymeric film laminated to a base substrate.

FIG. 14 is a side view of a process for creating another embodiment of a closure element with a directionally oriented polymeric film laminated to a base substrate.

### DETAILED DESCRIPTION OF THE INVENTION

While this invention is susceptible to embodiment in many different forms, there is shown in the drawings and will be described herein in detail specific embodiments thereof with the understanding that the present disclosure is to be considered as an exemplification of the principles of the invention and is not to be limited to the specific embodiments described.

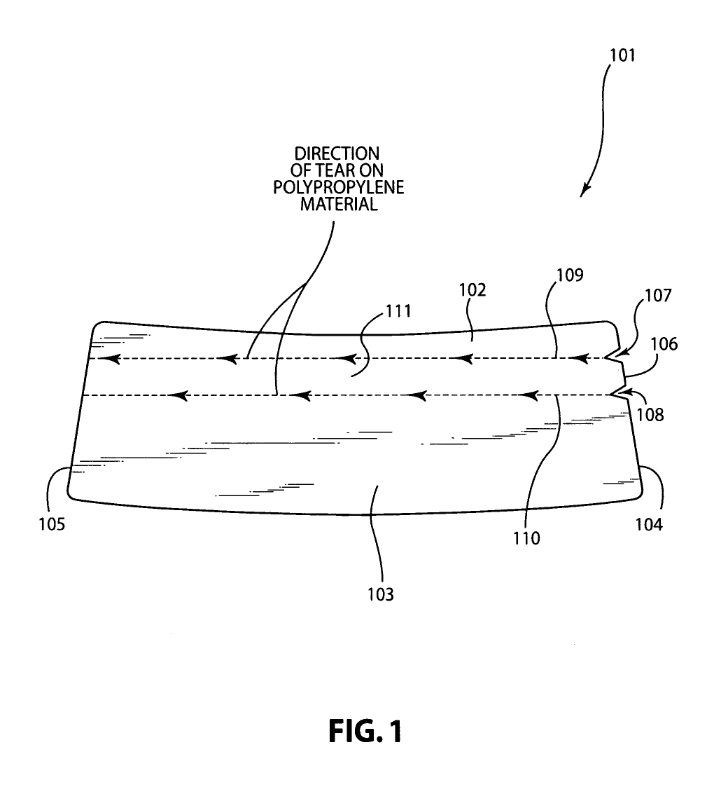

The disclosed embodiments overcome the disadvantages and limitations of the prior art by providing a neck band that is prepared utilizing single or multilayered uniaxially or directionally oriented film (straight-tear film) as a closure element that can be manually separated along a line around a separation point of a container. FIG. 1 depicts an embodiment of a directionally oriented film neck band. This neck band may contain product information, graphics, directions and the like and is made of a straight-tear material that has the ability to manually separate in a straight line in the direction indicated. As used herein, a “straight-tear film”, “directionally oriented film” and “uniaxially oriented film” refer to a polymeric film that can be torn manually along a straight line into at least two segments without the additional aid of a dimensional weakness such as a score or perforation in the direction of the tear. Typically, this occurs because the single or multilayered polymeric film is uniaxially or directionally oriented thereby allowing easy separation in the direction of the polymer orientation and resistance to separation in opposing or perpendicular directions to the polymer orientation. In general, a straight-tear film propagates a tear in the film along a straight line, with the tear variance minimized in the transverse direction from that line.

As depicted in FIG. 1, neck band 101 is the same general shape as conventional neck bands and comprises an upper portion 102 and a lower portion 103 each with ends 104 and 105. Die-cut notches 107 and 108 define an intermediate tab 106. When tab 106 is pulled to the left, it initiates a discontinuity between the upper portion 102 and a lower portion 103, shown in the drawing as lines 109 and 110 in the direction indicated. Unlike conventional perforated paper labels, the lines 109 and 110 on band 101 appear as a result of tearing in the direction of the straight-tear orientation of the film from which the band was made. When the tab 106 has been pulled completely to the left end 105, a strip of material 111 is released between the upper portion 102 of the neck band and the lower portion 103 of the neck band.

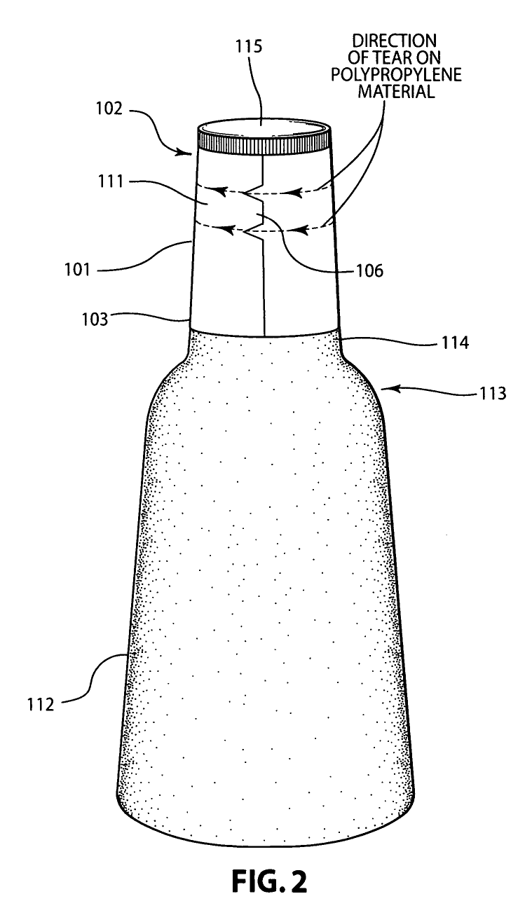

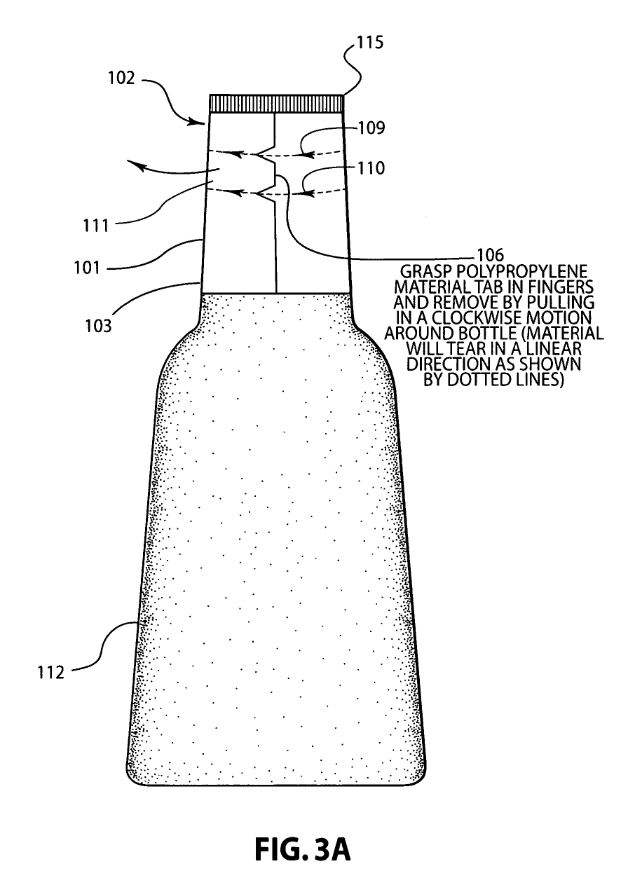

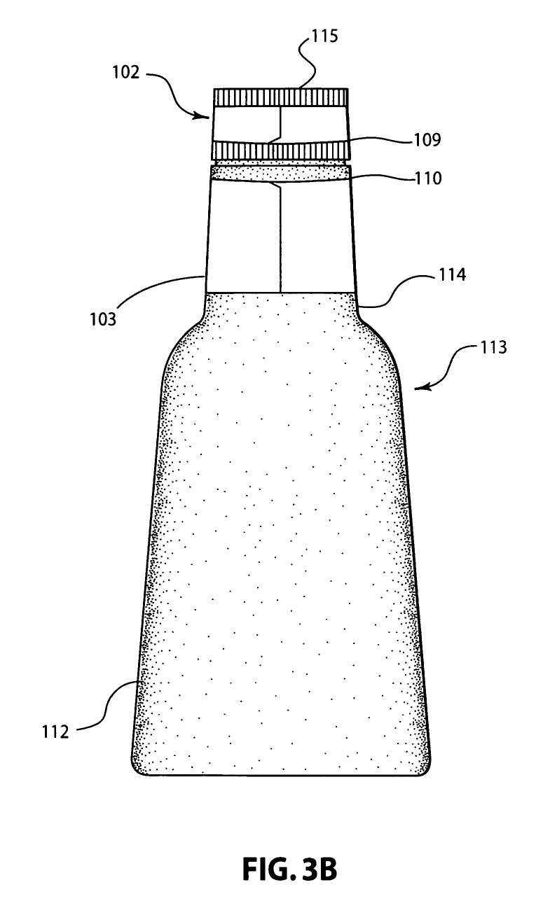

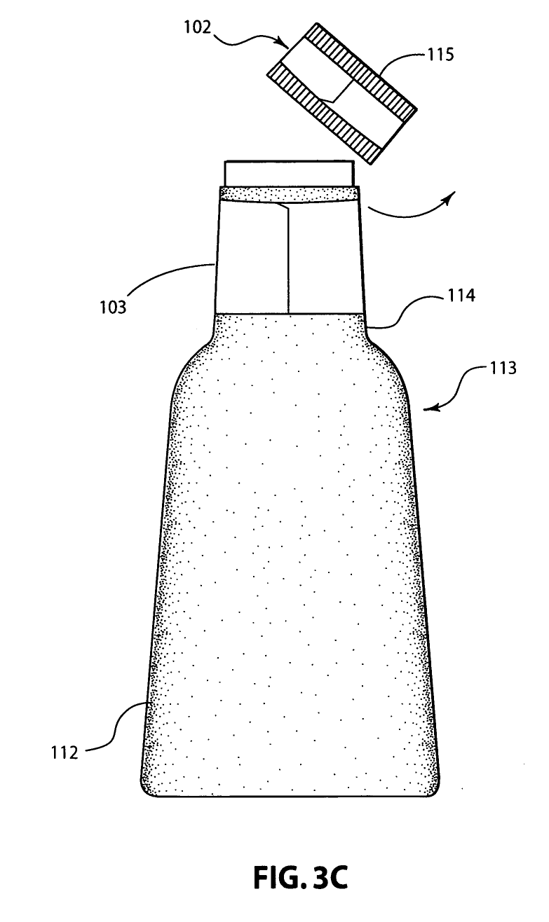

FIG. 2 shows the neck band 101 of FIG. 1 as applied to the neck 114 and cap 115 of a container 112, in this case a “narrow neck” salad dressing bottle. Although not shown in the drawing, the ends of the band 104 and 105 are wrapped around the neck and overlap each other on the back of the container and are secured by adhesive to one another, except as noted below. The upper portion 102 of the band is secured by adhesive to the cap 115, and the lower portion 103 of the band is secured to the neck, also by adhesive. The band 101 is designed so that the tab 106 lies below or adjacent the bottom of the cap 115 in an area of the band that is not glued to the cap (i.e. the width of 106 may be positioned at equal distances overlapping the cap and container), the neck or the other end 105 of the band. When the tab is pulled, as shown in FIG. 3A, the neck band material is torn on substantially straight lines 109 and 110 around the circumference of the neck. As a result, a piece of film 111 is removed around the circumference of the neck producing a discontinuity between the upper portion 102 that remains attached to the cap 115 and the lower portion 103 that remains attached to the neck 114 as shown in FIG. 3B. The separation of the film can be performed “manually” meaning that the film can be separated without having to cut or pierce the neck band, as is the case with conventional paper bands. After the neck band has been separated, the cap can be twisted and removed to open the container as shown in FIG. 3C.

In the disclosed embodiment shown in FIGS. 1, 2 and 3A though 3C, the neck band of the disclosed embodiments employs a tab to separate portions of the band. The tab is formed by cutting two “V”-shaped portions 107 and 108 into the edge 104 of the neck band. When the tab is pulled, parallel tears in the neck band are initiated at the apex of each “V.” As the user continues to pull the tab, the tears are completed around the neck band enabling separation of the middle portion thereby creating a discontinuity between the upper and lower portions of the neck band.

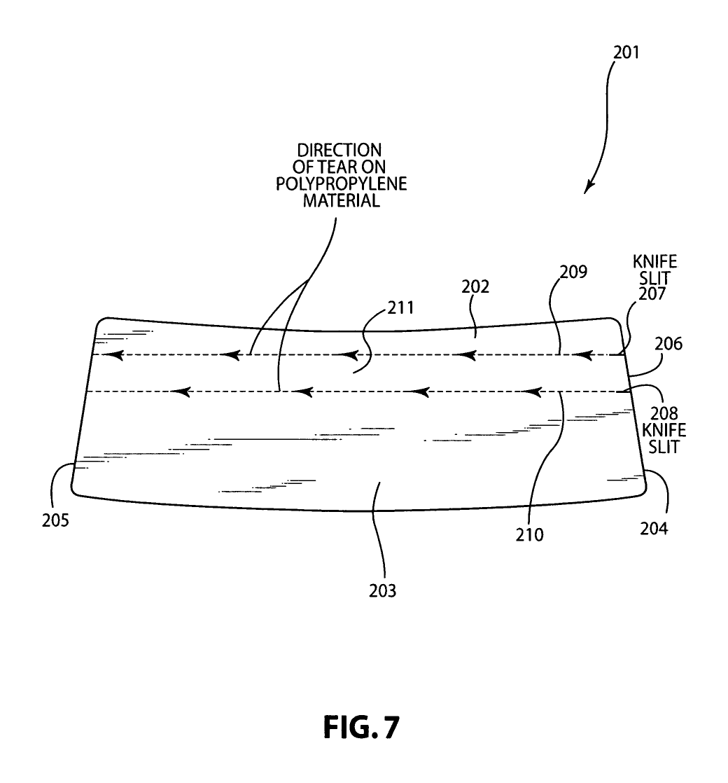

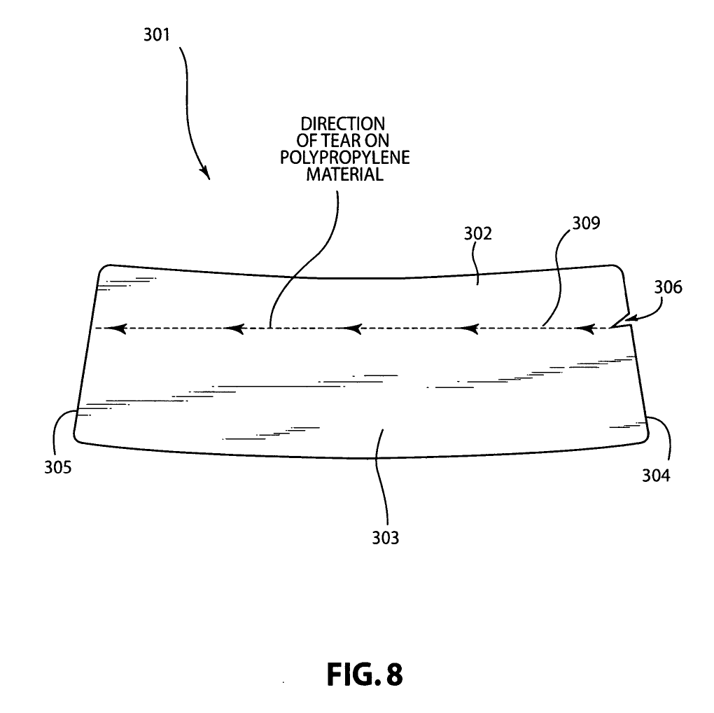

Additionally, other types of tabs can be employed utilizing other forms of tear-initiating features. For example, these tear-initiating features could include the use of slits instead of “V” slots (for example, as shown in FIG. 7) or a single knife slit or “V” slot (for example, as shown in FIG. 8). A tab could be formed as an extension of one end of the band rather than using slits or grooves. Other designs for tear-initiating features known to one skilled in the art can also be employed without straying from the spirit of the invention. Likewise, the neck bands of the disclosed embodiments can be employed without any tear-initiating feature. While such a construction would retain benefit over conventional technology, it may require user to employ a mechanism such as a fingernail, knife or other instrument to initiate the tear.

The embodiment depicted in FIGS. 1, 2 and 3A though 3C comprises a three-section neck band, i.e., opening removes a piece of material between the portions of the neck band secured to the cap and neck, respectively. This construction facilitates ease of operation and provides clear evidence of potential tampering. Any number of neck band sections can be employed depending on the number of tears initiated in the band. For example, a two-section embodiment can be utilized as shown in FIG. 8.

Neck band materials suitable for use in these embodiments may include any “straight-tear films.” Obviously, it is advantageous that the materials be inexpensive, that they be easy to manufacture, attach and handle, that they form a base for high quality printing and graphics, and that they provide superior water and vapor resistance. The selection of the straight-tear film may depend on the composite of properties desired for a particular application and may be selected from the group of materials including polypropylene films or any number of other polypropylene-based monopolymers, copolymers and blends that are capable of being directionally oriented so that a straight-tear film is produced.

One material that has been successfully used to prepare neck bands of this invention is PRIMAX® NA 350 or NA 250 film available from Avery Dennison, 7600 Auburn Road, Concord, Ohio USA. This material is a corona treated, flexible matte, white, opaque polyolefin (i.e., polypropylene) film having the following properties (NA 350):

| | |
|---|---|
| Thickness | 3.5 mils |
| Yield | 7,900 sq. in./lb. |
| Opacity | 88.0 maximum |
| Tensile Modulus | MD: 160,000 psi |
| | CD: 60,000 psi |
| Tensile Elongation | MD: 50% |
| | CD: 500% |
| Gurley Stiffness | MD: 30 mg |
| (typical value) | |
| Dyne (print surface) | Target: 45 |
| | Minimum: 40 |

Another suitable material is “DL2” film, also available from Avery Dennison. This material is also a corona treated, flexible matte, white, opaque polyolefin (i.e., polypropylene) film having the following properties:

| | |
|---|---|
| Thickness | 4.0 mils |
| Yield | 7,400 sq. in./lb. |
| Opacity | 85.0 maximum |
| Tensile Modulus | MD: 200,000 psi |
| | CD: 100,000 psi |
| Tensile Elongation | MD: 60% |
| | CD: 600% |
| Gurley Stiffness | MD: 65 minimum |
| (typical value) | |
| Dyne (print surface) | Target: 45 |
| | Minimum: 40 |

In one embodiment, the straight-tear film is a polypropylene-based polymer film that has been directionally oriented in a single direction, usually the “machine direction.” Such materials exhibit great strength and tear-resistance in directions other than the orientation direction providing a material which is essentially tear resistant in one direction and where tearing can be accomplished manually with ease in another direction. Straight-tear films utilized in the disclosed embodiments are not limited to polypropylene films that have been oriented in a single direction. Suitable straight-tear films may additionally be formed by careful selection of polymer type, molecular weight and degree of orientation.

The films prepared in accordance with the disclosed embodiments should have sufficient thickness to produce neck bands that are successfully employed in standard label application equipment, but not so thick as to add substantially to material costs. The appropriate thickness may vary slightly depending on the specific type of polypropylene-based polymer employed. Generally, however, the thickness may fall in the range of about 1 mil to 6 mil. Suitable films for use in the disclosed embodiments may be employed alone or as a co-extruded composites or laminates with other layers known to those skilled in the art. Examples of multi-layer composites include the PRIIMAX® NA 350, NA 250, DL2 films referenced previously as well as a film called Global Coex.

The materials utilized in the disclosed embodiments produce neck bands that are superior to those made of paper in a number of characteristics. First, neck bands of polypropylene-based films are physically stronger than paper, with the exception that they may be easily tom in a straight line in a single direction facilitating an opening. Because the bands may be easily torn for opening when intended without additional perforations, they do not present the deficiencies of paper bands (either perforated or un-perforated) as previously noted. Neck bands made of polypropylene-based films also provide an improved contamination barrier especially to moisture. Because polypropylene does not absorb water, it is substantially impervious to fluctuations in humidity and to deterioration due to direct contact with water, such as that encountered when placing labeled containers in an ice cooler. The absence of perforations or other discontinuities further enhances a moisture barrier or seal. In addition to the barrier properties of the disclosed neck bands, polypropylene-based polymers also provide a more attractive base for the presentation and preservation of graphics as compared to paper.

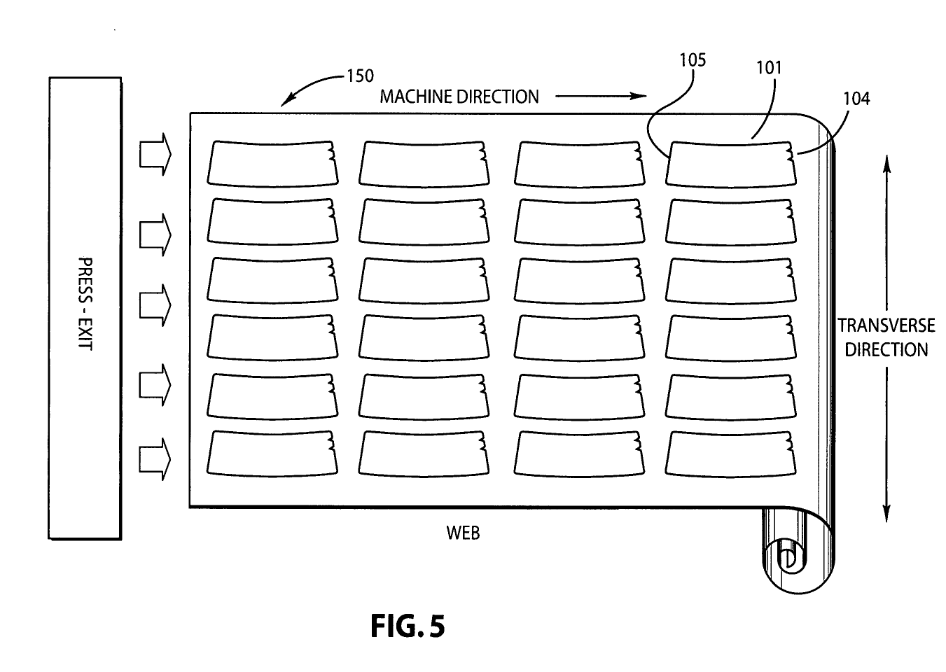

Polypropylene-based films can be prepared by any of the conventional methods known to one skilled in the art. Generally, these materials are thermoplastic. While the films are still hot, they may be stretched in the direction in which they are moving through the manufacturing process, i.e., the “machine direction”. This is illustrated, for example in FIG. 5, where the hot polypropylene-based film 150 from an extruder is passed between web rollers (not shown) moving at different speeds, i.e., the “down stream” rollers moving sufficiently faster than those “upstream,” so that the film is stretched in the “machine direction.” The stretched film can be “set” in that orientation by annealing. Thus the film has been stretched in the machine direction, but not stretched in the transverse direction. The continuous film is wound and formed into a roll for ease in delivery to customers.

Normally polypropylene film is stretched in both the machine direction and the transverse direction thereby enhancing the strength of the polymer in both directions. The vast majority of commercial applications require that polypropylene film be biaxially oriented. Specialty films are manufactured where the film is stretched in only the machine direction such as those films suitable for use in the disclosed embodiments. Although bi-directionally oriented films might be used in the disclosed embodiments, the amount of orientation in the second direction must be relatively insignificant, i.e., so that the film may be easily torn in a straight line. Similarly, if the polypropylene film is employed in the neck band as a laminate or otherwise with other layers, the composite must meet the same criteria, i.e., that it is capable of being torn in a straight line or does not significantly adversely affect the preferential separation of the straight-tear film.

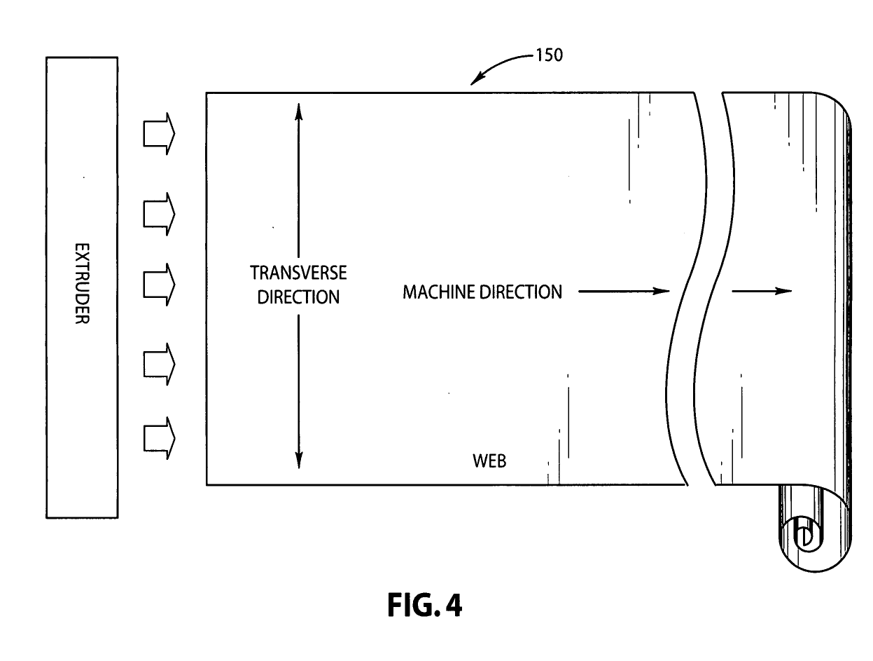

Neck bands may be manufactured from straight-tear polypropylene film using conventional technology. One manufacturing sequence is illustrated schematically in FIG. 5. For example, a roll of straight-tear film 150, such as that produced in the orientation process illustrated in FIG. 4, is fed to the feed table of the neck band manufacturing line. Accordingly, the film feedstock is fed in the machine oriented direction through the label manufacturing line. A typical printing line may be employed, such as a “Mark Andy/Comco, MSP 22” Proglide Flexographic Press, Press #2116D” available from Mark Andy located in St. Louis, Mo. Straight tear film 150 supplied in roll form, is threaded through the press and printed in up to nine colors in-line using ultra violet cured inks, water based film inks or solvent based inks. This may include imprinting of the product identifying information and trademark and various instructions. After printing, the bands are coated (i.e., UV, solvent or water based inks) in whole or in part. Typically, certain portions of the band are not varnished, such as the portions of the band edges that will overlap one another and be affixed in that position by glue, and portions of the band that may be subsequently printed with additional information, i.e., product expiration date and lot number, immediately prior to affixing neck bands to the containers. The printed film 150 then passes through a rotary die cutting station, which cuts the band to shape and delivers the film with printed and cut neck bands for stacking/bundling and delivery to the label applier. As shown schematically in FIG. 5, the neck bands are printed on the film and cut so that the ends 104 and 105 of each band 101 lie in the machine-oriented direction. Another option is to finish the labels with the web being slit into single rows of labels and rewound to be cut and applied on the labeler.

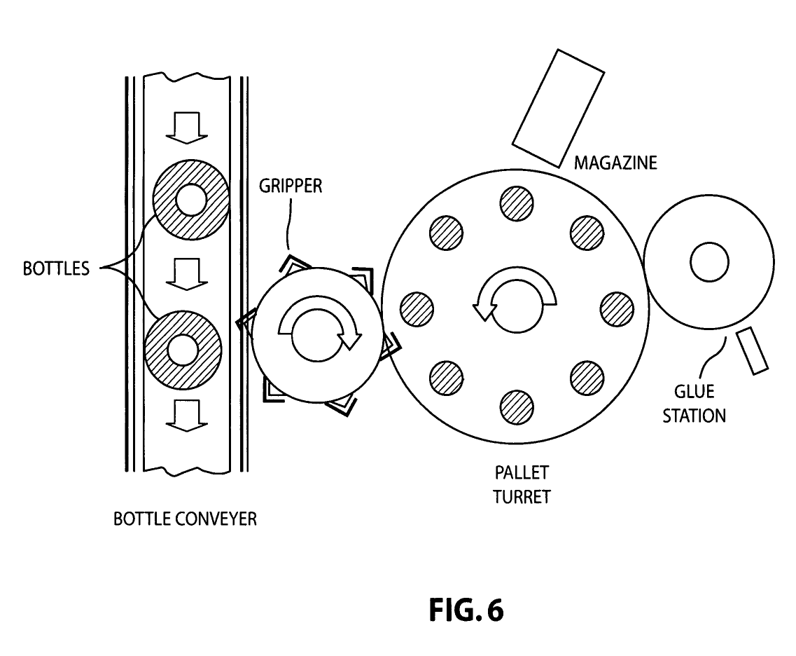

As mentioned previously, an advantage of the disclosed neck band embodiments is that they may be applied to containers using existing equipment and without structural modifications. In addition, the materials employed in the embodiments may be securely applied with cold or hot melt adhesive as well as pressure sensitive adhesive. For example, FIG. 6 depicts a top schematic view of a typical cold adhesive label application process. This depicted process is common to cold glue application systems available in the United States from Krones, Inc. of Franklin, Wis. or from Jagenberg, Inc. of Enfield, Conn. In the first step, adhesive is circulated along a roller at the glue station. A label pallet, which is the same shape of the neck band being applied, is exposed to glue roller, and glue is applied to the pallet. Individual neck bands 101, having been removed from film web 150, are fed from the label magazine onto the glue pallet, which applies glue to the back of the neck bands and transfers the band to a gripper wheel. The gripper wheel picks up the neck band and exposes the back of the band to the surface of the bottle, which is traveling along the bottle conveyer. Bottles are then conveyed through a series of brushes to wipe the neck band down smoothly and securely.

Those skilled in the art maintain sufficient knowledge to design the label pallet so that it applies adhesive to the back portions of the neck bands where it is required. As previously discussed, the neck bands of the disclosed embodiments do not generally contain adhesive behind the portion of the neck band 111 that will be removed upon tearing. However, it may be desirable to apply adhesive in the area between the notches 107 and 108 to hold the area adjacent the tab 106 in place to avoid unintended contact of the tab with surfaces, thereby initiating inadvertent tearing of the neck band.

Those skilled in the art will also appreciate that there are a number of other design options that might be employed using “straight-tear” film for a neck band. For example: FIG. 7 illustrates an alternative neck band embodiment. In this example, neck band 201 has an upper section 202 and lower section 203 and ends 204 and 205. The tear initiating feature is similar to that shown in FIG. 1, except that slits 207 and 208 are employed instead of “V”-shaped notches. A tab 206 is formed between the slits 207 and 208, which when pulled to the left causes straight line tearing as indicated along lines 209 and 210 thereby creating a discontinuity of intermediate section 211 from the upper section 202 and lower section 203.

FIG. 8 illustrates a two section neck band embodiment. In this case, neck band 301 has an upper section 302 and a lower section 303 and ends 304 and 305. The tear initiating feature consists of a single “V”-shaped groove 306 at which a tear can be initiated utilizing the sides and bottom of the groove to initiate a tear along line 309 thereby creating a discontinuity in the neck band between the upper and lower portions 302 and 303, respectively.

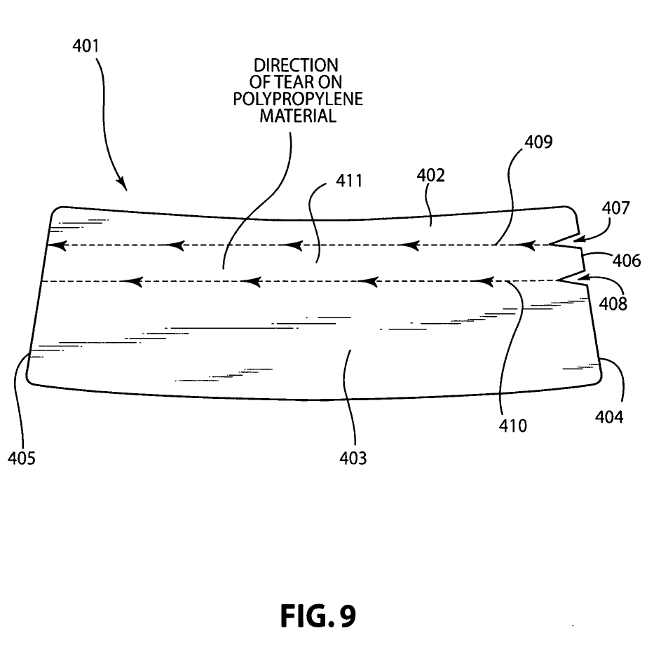

FIG. 9 illustrates a neck band embodiment similar to that shown in FIG. 1. Again, neck band 401 consists of upper portion 402 and lower portion 403 with ends 404 and 405. The tear initiating feature is similar to that in FIG. 1 and comprises a tab 406 formed by “V”-shaped grooves 407 and 408. Pulling the tab to the left initiates tearing of the straight-tear film along lines 409 and 410, resulting in separation of intermediate material 411. The grooves 407 and 408 are deeper than those of the neck band in FIG. 1.

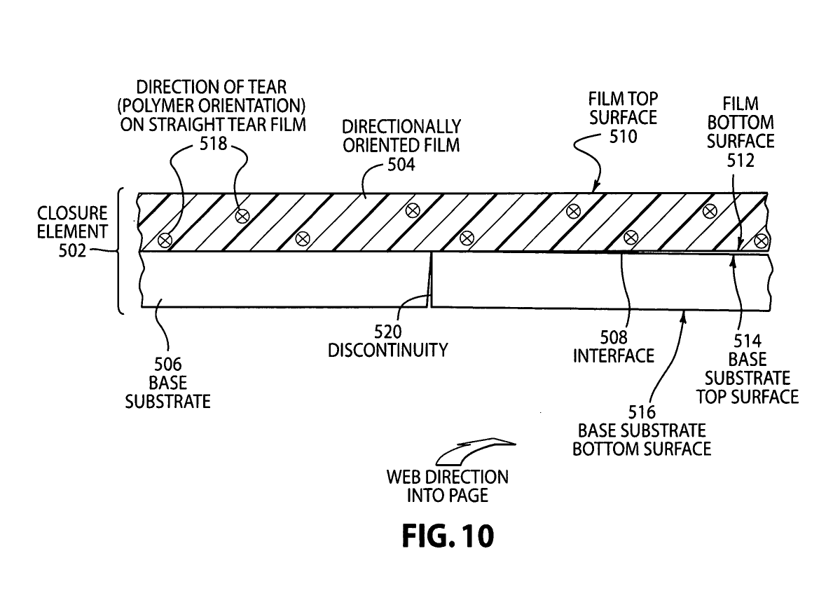

FIG. 10 is an edge-on view of an embodiment of a closure element 502 (neck band) with a directionally oriented polymeric film 504 laminated to an adhesive interface layer or base substrate 506. As shown in FIG. 10, a cross sectional view of a closure element 502 that has been extruded as a single or multi-layer, directionally oriented film 504 and is depicted in this view with the direction of tear (polymer orientation) 518 being into the page. The directionally oriented film 504 has a film top surface 510 that is oriented to be the outermost surface when the closure element 502 is used a typical application as a tamper evident or sanitary seal. The film bottom surface 512 is secured to a base substrate 506 that acts as an adhesive interface between the closure element 502 and a container such as a bottle with a removable closure such as a cap. The film bottom surface 512 is typically secured to the base substrate top surface 514 by a lamination process. Both of these surfaces (512 and 514) are, therefore, referred to as laminate surfaces.

A variety of polymers may be utilized for directionally oriented polymeric films such as polypropylene, polyethylene, polyester, polyamide, polystyrene, and polycarbonate. Difficulties though, can arise when attempting to adhere directionally oriented polymeric film 504 directly to glass or plastic container parts. Common polymers utilizing polyolefin, (polymerization of olefins, such as polyethylene from ethylene, polypropylene from propylene, or polybutene from butylenes) for example, can often be difficult to bond to containers and their related components. It is therefore desirable to utilize a base substrate 506 that acts as an intermediary between the directionally oriented polymeric film 504 and the glass or plastic container parts. The introduction of a base substrate 506 (such as a layer of paper in the 20 to 40 pound range) that is secured to the directionally oriented polymeric film 504 by a process such as lamination can be utilized to overcome the difficulty of adhesion of the film to the container. A variety of materials may be used for the base material and may typically be in the form of a paper layer, although any material that has good adhesion qualities (such as quick adhesive absorption) and can be readily cut, scored, perforated, or the like, can be used.

Lamination of the base substrate 506 (in this example paper) to the directionally oriented polymeric film 504 can be accomplished by laying down a layer of adhesive on either or both of the laminate surfaces (with or without a primer) to form a permanent bond between the laminate layers using a variety of adhesives and processes such as water based adhesives, solvent based adhesives, dry based adhesives, and UV cured adhesives. The layers may be flood coated, sprayed or selectively coated on a process similar to printing that uses screening plates or other processes commonly used in the adhesives industry to precisely and selectively apply (register) the adhesive to the laminate surfaces to allow specific functionality and applicability of the closure element. When the lamination of the layers is performed as a separate operation, time issues that constrain the high speed labeling process are not as great. This makes available a greater number of process choices for permanently binding the layers together and also allows the ability to laminate and sheet the laminated material to be able to run through sheet fed presses.

Once the layers have been permanently laminated together at an interface 508, a discontinuity 520 can be introduced to the base substrate 506 layer by cutting, scoring, perforating or the like. This discontinuity 520 lies parallel to the predominant direction of orientation (machine direction) of the polymer chains within the directionally oriented polymeric film 504. Since there is no preferential direction of tear in the adhesive interface layer (base substrate), a discontinuity in the thickness that is positioned substantially parallel to, and aligned with, an intended separation line of said laminate, will allow this laminate layer to cleanly tear in a straight line as a single element. This discontinuity can be through the entirety of the thickness of the substrate sheet or merely to allow the substrate to preferentially tear along the intended separation line. Typically, the greater the discontinuity, the better the cosmetic properties of the torn closure element surfaces.

Once the closure element 502 has been created by the lamination and scoring processes it can be stored for a period of time or the material can be immediately applied to a container. Typically, in complicated manufacturing and packaging processes, where time is of the essence, the closure elements and labels need to be bonded to product containers with minimal cure time. This does not allow for many standard adhesive processes that have long set times or cure times or secondary processes such as UV curing. The aforementioned the apparatus allows for the lamination step to occur under minimal time and space constraints, and provides a closure element 502 with straight-tear properties and a paper backing that facilitates rapid short-cure manufacturing processes with bonding occurring between the substrate bottom surface 516 and the container surface.

The aforementioned embodiments additionally allow for a variety of the application possibilities involving the application of graphical indicia and design. For example, the directionally oriented polymeric film 504 may convey standard graphical information with the surface printing on the film top surface 510. If a transparent or semi transparent polymeric film is used, a reverse print on the film bottom surface 512 may be utilized to convey graphical information wherein the ink remains protected beneath the layer of polymeric film. Similarly, a surface printing may be utilized on the base substrate top surface 514 with graphical information being conveyed through the transparent or semi transparent directionally oriented polymeric film 504. In addition to the graphic versatility of the laminate, the disclosed embodiments also lend themselves to applicability in many other value-added processes such as hot or cold foil stamping, embossing, polygraphic processes, micro etching, bronzing or the like.

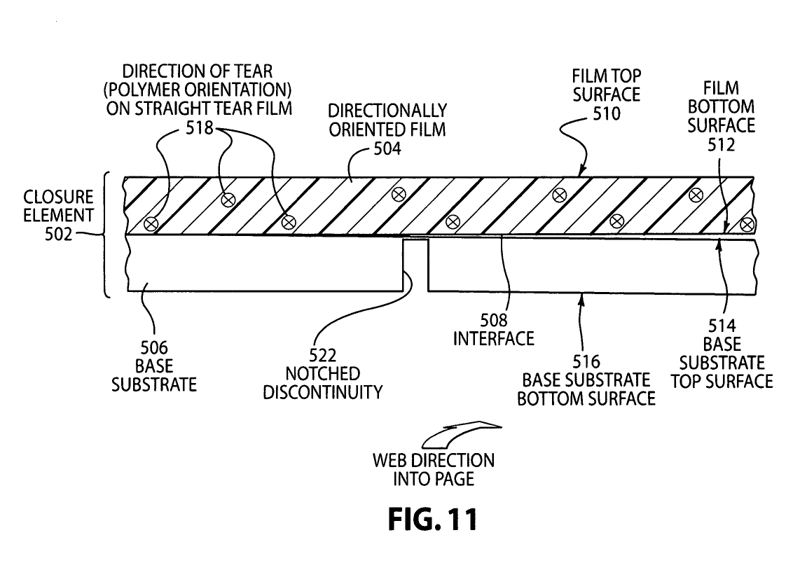

The FIG. 11 is an edge-on view of an embodiment of a closure element 502 with a directionally oriented polymeric film 504 laminated to a base substrate 506. As similarly shown in FIG. 10, a cross sectional view of a closure element 502 that has been extruded as a single or multi-layer, directionally oriented film 504 and is depicted in this view with the direction of tear (polymer orientation) 518 being into the page. In embodiment depicts a notched discontinuity 522 with increased width in the area of separation of the base substrate 506. This embodiment allows for a highly cosmetic tear featuring clean edges.

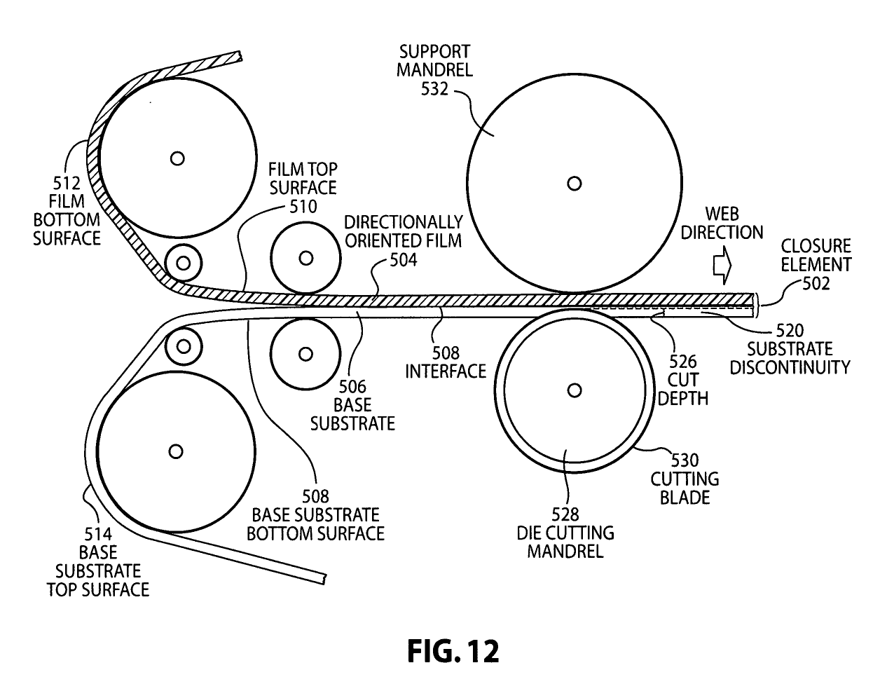

FIG. 12 is a side view of a process for creating a directionally oriented polymeric film 504 laminated to a base substrate 506. As shown in FIG. 12, a side view of a closure element web that has been extruded as a single or multi-layer, directionally oriented film 504 and is depicted in this view with the direction of tear (web direction) 518 being from left to right on the page. The directionally oriented film 504 has a film top surface 510 that is oriented to be the outermost surface and the film bottom surface 512 is secured to a base substrate 506 that acts as an adhesive interface between the closure element 502 and a container. The film bottom surface 512 is secured to the base substrate top surface 514 by a lamination process that becomes interface 508.

In the depicted process, the film bottom surface 512 of a roll of directionally oriented film 504 is brought in contact with a base substrate top surface 514 where laminate adhesive is used to bind the two players together (not shown). For example, a directionally oriented film 504 with a UV cured pressure sensitive adhesive (not shown) and brought in contact with a paper and pressed by rollers in a continuous web. A die cutting mandrel 528 is then used in conjunction with cutting blade 530 and support mandrel 532 to precisely cut a discontinuity 520 completely or nearly completely through the paper layer. In order to facilitate such a cut, the difference between the diameter of the cutting blade 530 and the diameter of the die cutting mandrel 528, is approximately the thickness of the paper. This process produces the closure element 502 as depicted in FIG. 10 with a substrate discontinuity 520 having a cut depth 526 which is approximately the thickness of the base substrate 506. The aforementioned processes may therefore be used to create single or multiple discontinuities on the base substrate to accommodate various pull tab geometries such as a tab that splits the closure element into two pieces, or one that splits into three distinct pieces for example. A closure element that splits into two pieces can be used to facilitate, for instance, a cap seal where the discontinuity is placed between a screw top cap (removable closure) and a necked bottle. Upon twisting the screw top cap to open the container, since the upper portion of the container element is affixed to the cap and the lower portion is affixed to the container, a sheer force is transmitted from the affixed portions of the closure element to the free center portion and concentrated at the discontinuity. This causes the directionally oriented film 504 to fracture and separate at the discontinuity and provide a cosmetic tamper evident and sanitary seal.

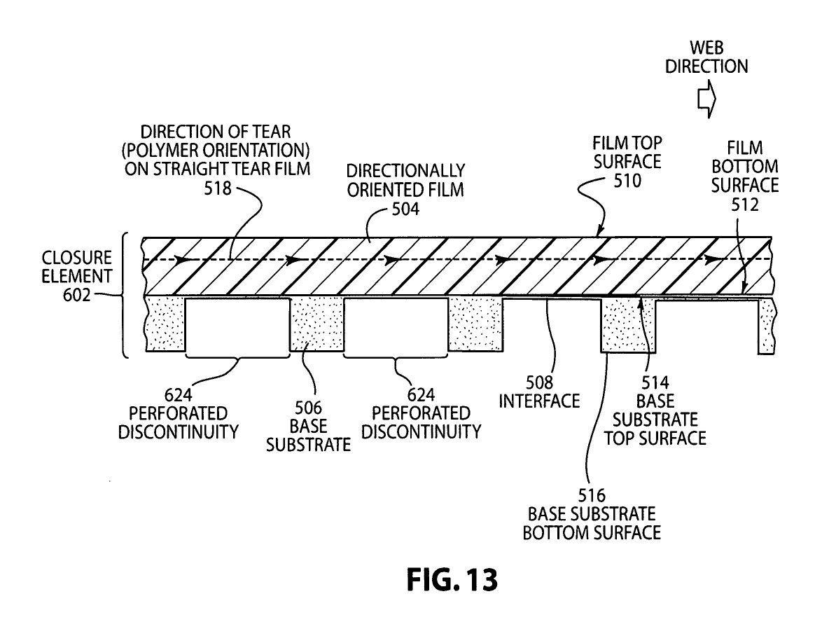

FIG. 13 is a side edge view of an embodiment of a neck band 602 with a directionally oriented polymeric film 504 laminated to a base substrate 506. As similarly shown in FIG. 10, a cross sectional view of a closure element 502 that has been extruded as a single or multi-layer, directionally oriented film 504 and is depicted in this view with the direction of tear (polymer orientation) 518 being from left to right on the page. This embodiment depicts a perforated discontinuity 624 where the discontinuity is intermittent through the length of the base substrate 506. This embodiment allows for a less cosmetic tear featuring that as depicted in FIG. 10 but allows for greater ease and tolerance in manufacturing the closure element 602. As with the discontinuities depicted in FIGS. 10 and 11, the depth of the discontinuities 624 are completely or nearly completely through the paper layer to facilitate a straight tear.

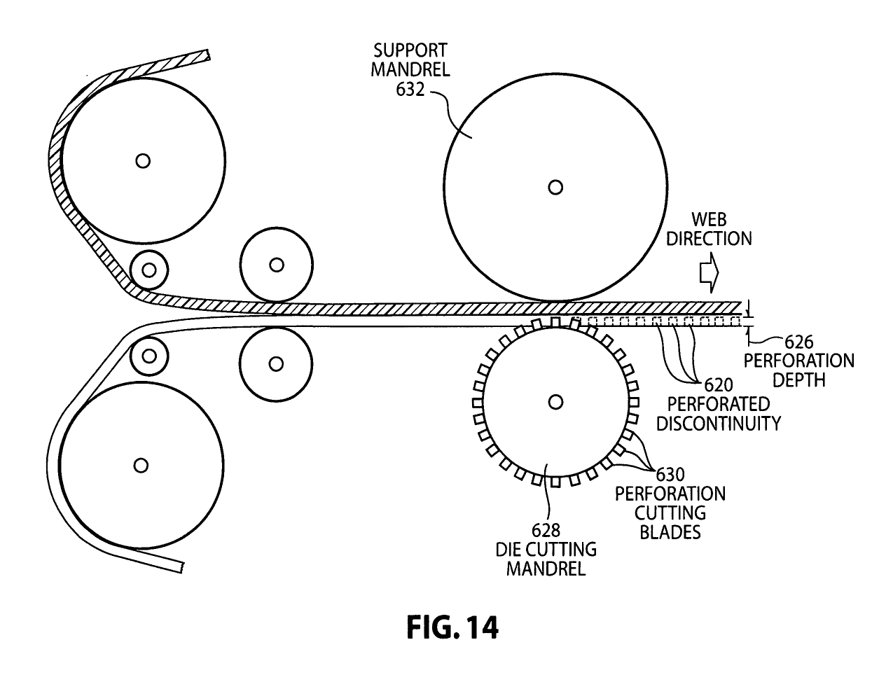

FIG. 14 is a side view of a process for creating a directionally oriented polymeric film 604 laminated to a base substrate 506. As was similarly shown in FIG. 12, a side view of a closure element web that has been extruded as a single or multi-layer, directionally oriented film and is depicted in this view with the direction of tear (web direction) 518 being from left to right on the page. In the depicted process, the film bottom surface 512 and of a roll of directionally oriented film 504 is brought in contact with a base substrate top surface 514 where laminate adhesive is used to bind the two players together (not shown).

A die cutting mandrel 628 is then used in conjunction with perforation cutting blades 630 and support mandrel 632 to precisely cut a perforated discontinuity 620 completely or nearly completely through the paper layer. In order to facilitate such a cut, the difference between the diameter of the perforation cutting blades 630 and the diameter of the die cutting mandrel 628, is approximately the thickness of the paper. This process produces the closure element 502 as depicted in FIG. 13 with a substrate perforated discontinuity 620 having a perforation depth 626 which is approximately the thickness of the base substrate 506.

The foregoing description of the invention has been presented for purposes of illustration and description. It is not intended to be exhaustive or to limit the invention to the precise form disclosed, and other modifications and variations may be possible in light of the above teachings. The embodiment was chosen and described in order to best explain the principles of the invention and its practical application to thereby enable others skilled in the art to best utilize the invention in various embodiments and various modifications as are suited to the particular use contemplated. It is intended that the appended claims be construed to include other alternative embodiments of the invention except insofar as limited by the prior art.

1. A closure element for a container comprising:
a directionally oriented polymeric film that can be manually torn in a substantially straight line that corresponds to a predominant direction of orientation of said directionally oriented polymeric film;
a non-directionally oriented base substrate secured to said directionally oriented polymeric film to form a directionally oriented laminate;
a first discontinuity in the thickness of said base substrate substantially parallel to, and aligned with, an intended separation line of said laminate that allows said laminate to tear as a single element;
a second discontinuity on a perpendicular edge to said intended separation line that concentrates force on at least one tear initiation point; and,
an adhesive that adheres at least a portion of said base substrate to said container.

2. The closure element of claim 1 further comprising:
a third discontinuity in the thickness of said base substrate positioned substantially parallel to said first discontinuity, and aligned with an intended separation line of said laminate that allows a portion of said laminate to be removed from said closure.

3. The closure element of claim 2 wherein said intermediate tab lies between said first discontinuity and said third discontinuity.

4. The closure element of claim 2 wherein said intermediate tab enables the separation of said closure element into an upper portion and a lower portion by removing a central portion of the closure.

5. The closure element of claim 2 wherein said intermediate tab enables the removal of at least a portion of said closure.

6. The closure element of claim 1 wherein said intermediate tab enables the separation of said closure element into an upper portion and a lower portion without the removal of a central portion of said closure.

7. The closure element of claim 1 wherein said directionally oriented polymeric film is selected from the group consisting of polypropylene, polyethylene, polyester, polyamide, polystyrene, and polycarbonate.

8. The closure element of claim I wherein said directionally oriented polymeric film is sufficiently transparent such that graphic information may be communicated through said film.

9. The closure element of claim 1 wherein said directionally oriented polymeric film is opaque.

10. The closure element of claim 1 wherein said directionally oriented polymeric film displays printed graphic information.

11. The closure element of claim I wherein said base substrate contains printed graphic information on a surface interfacing with said directionally oriented polymeric film and said film is sufficiently transparent such that said graphic information may be communicated through said film.

12. The closure element of claim 1 wherein said polypropylene-based material is selected from the group consisting of PRIIMAX® NA 350, PRIIMAX® NA 250, Global Coex, and DL2 films.

13. The closure element of claim 1 wherein a laminate adhesive is used to secure said base substrate to said directionally oriented polymeric film, and said laminate adhesive is selected from the group consisting of water based adhesive, solvent based adhesive, dry based adhesive, and UV cured adhesive.

14. The closure element of claim 1 wherein said adhesive that adheres at least a portion of said base substrate to said container is selected from the group consisting of water based adhesive, solvent based adhesive, dry based adhesive, and UV cured adhesive.

15. The closure element of claim 1 wherein said first discontinuity is substantially completely through said thickness of said base substrate.

16. The closure element of claim 1 wherein said first discontinuity is substantially continuous through the length of said closure.

17. The closure element of claim 1 wherein said first discontinuity is intermittent through the length of said closure.

18. The apparatus of claim 1 wherein said closure element functions as a tamper evident seal for said container.

19. The apparatus of claim 1 wherein said closure element functions as a sanitary seal for said container.

20. The apparatus of claim I wherein said closure element is a circumferential neck band for a necked container with a removable cap.

21. The closure element of claim 1 wherein said base substrate comprises paper.

22. The closure element of claim 1 wherein said base substrate comprises natural fiber.

23. The closure element of claim 1 wherein said base substrate comprises synthetic fiber.

24. A container having a closure element as defined in claim 1.

25. A method of providing a closure element for a container comprising:
providing a directionally oriented polymeric film that can be manually torn in a substantially straight line that corresponds to a predominant direction of orientation of said directionally oriented polymeric film;
securing a base substrate to said directionally oriented polymeric film to create a directionally oriented laminate;
creating and positioning a first discontinuity in the thickness of said base substrate substantially parallel to, and aligned with, an intended separation line of said laminate that allows said laminate to tear as a single element;
creating a second discontinuity on a perpendicular edge to said intended separation line on said laminate that creates at least one tear initiation point; and,
adhering at least a portion of said base substrate to said container.

26. The method of claim 25 further comprising the step:
initiating and propagating a substantially straight tear to said laminate on said container by applying a pulling force to said intermediate tab; and,
removing at least a portion of said closure element to provide access to said container.

27. The method of claim 25 further comprising the step:
creating and positioning a third discontinuity in the thickness of said base substrate positioned substantially parallel to said first discontinuity, and aligned with an intended separation line of said laminate that allows a portion of said laminate to be removed from said closure.

28. The method of claim 27 further comprising the step:
positioning said intermediate tab between said first discontinuity and said third discontinuity.

29. The method of claim 27 further comprising the step:
separating said closure element into an upper portion and a lower portion by removing a central portion of said closure.

30. The method of claim 25 further comprising the step:
separating said closure element into an upper portion and a lower portion without removing a central portion of said closure.

31. The method of claim 25 further comprising the step:
selecting said directionally oriented polymeric film from the group consisting of
polypropylene, polyethylene, polyester, polyamide, polystyrene, and polycarbonate.

32. The method of claim 25 further comprising the step:
placing printed graphic information on said directionally oriented polymeric film.

33. The method of claim 25 further comprising the step:
placing graphic information on a laminate interface surface of said directionally oriented polymeric film; and,
conveying said graphic information through said directionally oriented polymeric film.

34. The method of claim 25 further comprising the step:
placing graphic information on a laminate interface surface of said layer of base substrate; and,
conveying said graphic information through said directionally oriented polymeric film.

35. The method of claim 25 further comprising the step:
selecting said directionally oriented polymeric film from the group consisting of PRIIMAX® NA 350, PRIIMAX® NA 250, Global Coex, and DL2 films.

36. The method of claim 25 further comprising the step:
selecting said laminate adhesive from the group consisting of water based adhesive, solvent based adhesive, dry based adhesive, and UV cured adhesive.

37. The method of claim 25 wherein said step of adhering at least a portion of said base substrate to said container with an adhesive further comprises:
adhering said base substrate with an adhesive selected from the group consisting of water based adhesive, solvent based adhesive, dry based adhesive, and UV cured adhesive.

38. The method of claim 25 further comprising the step:
extending said first discontinuity substantially completely through said thickness of said base substrate.

39. The method of claim 25 further comprising the step:
extending said first discontinuity substantially throughout the length of said closure.

40. The method of claim 25 further comprising the step:
creating a perforation by intermittently extending said first discontinuity substantially throughout the length of said closure.

41. The method of claim 25 further comprising the step:
utilizing said closure element is a tamper evident seal between said removable closure element and said container.

42. The method of claim 25 further comprising the step:
utilizing said closure element is a sanitary seal between said removable closure element and said container.

43. The method of claim 25 further comprising the step:
utilizing said closure element is a circumferential neck band for a necked container with a removable cap.

44. The method of claim 25 wherein said step of securing a base substrate to said directionally oriented polymeric film to create a directionally oriented laminate further comprises, said base substrate comprising paper.

45. The method of claim 25 wherein said step of securing a base substrate to said directionally oriented polymeric film to create a directionally oriented laminate further comprises, said base substrate comprising natural fiber.

46. The method of claim 25 wherein said step of securing a base substrate to said directionally oriented polymeric film to create a directionally oriented laminate further comprises, said base substrate comprising synthetic fiber.

47. A neck band for a necked container with a removable closure comprising:
a directionally oriented polymeric film that can be manually torn in a substantially straight line that corresponds to a predominant direction of orientation of said directionally oriented polymeric film;
a layer of paper laminated to said directionally oriented polymeric film with a laminate adhesive to form a directionally oriented laminate;
a first discontinuity in the thickness of said paper positioned substantially parallel to, and aligned with, an intended separation line of said laminate that allows said laminate to tear as a single element;
an intermediate tab on said neck band that is formed by a second discontinuity on a perpendicular edge to said intended separation line that creates at least one initiation point for a circumferential tear; and,
an adhesive that adheres at least a portion of said paper substrate to said neck and said removable closure of said container.

48. The neck band of claim 47 further comprising:
a third discontinuity in the thickness of said paper positioned substantially parallel to said first discontinuity, and aligned with an intended separation line of said laminate that allows a portion of said laminate to be removed from said neck band.

49. The neck band of claim 48 wherein said intermediate tab lies between said first discontinuity and said third discontinuity.

50. The neck band of claim 48 wherein said intermediate tab enables the separation of said neck band into an upper portion and a lower portion by removing a central portion of the neck band.

51. The neck band of claim 47 wherein said intermediate tab enables the removal of at least a portion of said neck band.

52. The neck band of claim 47 wherein said intermediate tab enables the separation of said neck band into an upper portion and a lower portion without the removal of a portion of the neck band.

53. The neck band of claim 47 wherein said directionally oriented polymeric film is selected from the group consisting of polypropylene, polyethylene, polyester, polyamide, polystyrene, and polycarbonate.

54. The neck band of claim 47 wherein said directionally oriented polymeric film is sufficiently transparent such that graphic information may be communicated through said film.

55. The neck band of claim 47 wherein said directionally oriented polymeric film is opaque.

56. The neck band of claim 47 wherein said directionally oriented polymeric film displays printed graphic information.

57. The neck band of claim 47 wherein said layer of paper contains printed graphic information on a surface interfacing with said directionally oriented polymeric film and said film is sufficiently transparent such that said graphic information may be communicated through said film.

58. The neck band of claim 47 wherein said polypropylene-based material is selected from the group consisting of PRIIMAX® NA 350, PRIIMAX® NA 250, Global Coex, and DL2 films.

59. The neck band of claim 47 wherein said laminate adhesive is selected from the group consisting of water based adhesive, solvent based adhesive, dry based adhesive, and UV cured adhesive.

60. The neck band of claim 47 wherein said adhesive that adheres at least a portion of said paper substrate to said neck and said removable closure of said container is selected from the group consisting of water based adhesive, solvent based adhesive, dry based adhesive, and UV cured adhesive.

61. The neck band of claim 47 wherein said first discontinuity is substantially completely through said thickness of said paper.

62. The neck band of claim 47 wherein said first discontinuity is substantially continuous through the length of said neck band.

63. The neck band of claim 47 wherein said first discontinuity is intermittent through the length of said neck band.

64. The apparatus of claim 47 wherein said neck band is a tamper evident seal for said removable closure on said necked container.

65. The apparatus of claim 47 wherein said neck band is a sanitary seal for said removable closure on said necked container.

66. A method of providing a circumferential neck band for a necked container with a removable closure comprising:
providing a directionally oriented polymeric film that can be manually torn in a substantially straight line that corresponds to a predominant direction of orientation of said directionally oriented polymeric film;
laminating a layer of paper to said directionally oriented polymeric film with a UV activated pressure sensitive adhesive thereby creating a directionally oriented laminate;
creating and positioning a first discontinuity in the thickness of said paper substantially parallel to, and aligned with, an intended separation line of said laminate that allows said laminate to tear as a single element;
creating an intermediate tab that concentrates force on at least one tear initiation point by forming a second discontinuity on said neck band at an edge that is perpendicular to said intended separation line; and,
adhering at least a portion of said paper substrate to said neck and said container with an adhesive.

67. The method of claim 66 further comprising the step:
initiating and propagating a circumferential tear to said laminate around said neck of said container by applying a pulling force to said intermediate tab; and,
removing at least a portion of said neck band to access said removable closure.

68. The method of claim 66 further comprising the step:
creating and positioning a third discontinuity in the thickness of said paper positioned substantially parallel to said first discontinuity, and aligned with an intended separation line of said laminate that allows a portion of said laminate to be removed from said neck band.

69. The method of claim 68 further comprising the step:
positioning said intermediate tab between said first discontinuity and said third discontinuity.

70. The method of claim 68 further comprising the step:
separating said neck band into an upper portion and a lower portion by removing a central portion of said neck band.

71. The method of claim 66 further comprising the step:
separating said neck band into an upper portion and a lower portion without removing a portion of said neck band.

72. The method of claim 66 further comprising the step:
selecting said directionally oriented polymeric film from the group consisting of
polypropylene, polyethylene, polyester, polyamide, polystyrene, and polycarbonate.

73. The method of claim 66 further comprising the step:
placing printed graphic information on said directionally oriented polymeric film.

74. The method of claim 66 further comprising the step:
placing graphic information on a laminate interface surface of said directionally oriented polymeric film; and,
conveying graphic information through said directionally oriented polymeric film.

75. The method of claim 66 further comprising the step:
placing graphic information on a laminate interface surface of said layer of paper; and,
conveying graphic information through said directionally oriented polymeric film.

76. The method of claim 66 further comprising the step:
selecting said directionally oriented polymeric film from the group consisting of PRIIMAX® NA 350, PRIIMAX® NA 250, Global Coex, and DL2 films.

77. The method of claim 66 further comprising the step:
selecting said laminate adhesive from the group consisting of water based adhesive, solvent based adhesive, dry based adhesive, and UV cured adhesive.

78. The method of claim 66 wherein said step of adhering at least a portion of said paper substrate to said neck and said container with an adhesive further comprises:
adhering said paper substrate with an adhesive selected from the group consisting of water based adhesive, solvent based adhesive, dry based adhesive, and UV cured adhesive.

79. The method of claim 66 further comprising the step:
extending said first discontinuity substantially completely through said thickness of said paper.

80. The method of claim 66 further comprising the step:
extending said first discontinuity substantially throughout the length of said neck band.

81. The method of claim 66 further comprising the step:
creating a perforation by intermittently extending said first discontinuity substantially throughout the length of said neck band.

82. The method of claim 66 further comprising the step:
utilizing said neck band is a tamper evident seal between said removable closure and said necked container.

83. The method of claim 66 further comprising the step:
utilizing said neck band is a sanitary seal between said removable closure and said necked container.

84. A means for providing a closure element for a container comprising:
a means for providing a directionally oriented polymeric film that can be manually torn in a substantially straight line that corresponds to a predominant direction of orientation of said directionally oriented polymeric film;
a means for securing a base substrate to said directionally oriented polymeric film to create a directionally oriented laminate;
a means for creating and positioning a first discontinuity in the thickness of said base substrate substantially parallel to, and aligned with, an intended separation line of said laminate that allows said laminate to tear as a single element;
a means for creating a second discontinuity on a perpendicular edge to said intended separation line on said laminate that creates at least one tear initiation point; and,
a means for adhering at least a portion of said base substrate to said container.

85. A neck band for a necked container with a removable closure comprising:
a directionally oriented polymeric film that can be manually torn in a substantially straight line that corresponds to a predominant direction of orientation of said directionally oriented polymeric film;
a first discontinuity in the thickness of said polymeric film positioned substantially parallel to, and aligned with, an intended separation line of said laminate that allows said polymeric film to tear as a single element;
an intermediate tab on said neck band that is formed by a second discontinuity on a perpendicular edge to said intended separation line that creates at least one initiation point for a circumferential tear, said intermediate tab enables the separation of said neck band into an upper portion and a lower portion without the removal of a portion of the neck band; and,
an adhesive that adheres at least a portion of said polymeric film to said neck and said removable closure of said container.
